(19) United States
(12) Patent Application Publication
(10) Pub. No.: US 2025/0136201 A1
(43) Pub. Date: May 1, 2025

(54) CRAWLER AND SNOW SWEEPING EQUIPMENT

(71) Applicant: SHENZHEN HANYANG TECHNOLOGY CO., LTD., Shenzhen (CN)

(72) Inventors: Yang Huang, Shenzhen (CN); Taotao Zhu, Shenzhen (CN); Yongqi Song, Shenzhen (CN); Yafeng Wang, Shenzhen (CN)

(21) Appl. No.: 19/004,229

(22) Filed: Dec. 28, 2024

Related U.S. Application Data
(63) Continuation of application No. PCT/CN2023/136800, filed on Dec. 6, 2023.

(30) Foreign Application Priority Data
May 30, 2023 (CN) 202321348579.1
Jul. 26, 2023 (CN) 202321990435.6

(51) Int. Cl. B62D 55/088; B62D 55/24

(52) U.S. Cl. CPC B62D 55/0882; B62D 55/24

(57) ABSTRACT

Provided are a crawler and a snow sweeping equipment. The crawler includes a crawler body, driving wheel, driven wheel, first frame body, second frame body, first barrier and second barrier. The driving wheel and the driven wheel are respectively arranged at two ends of the inner side of the crawler body, so that the driving wheel and driven wheel are connected through the crawler body. The first frame body and second frame body are respectively arranged at two opposite sides of the axis direction of the driving wheel, so that the driving wheel and driven wheel are connected. The first barrier and second barrier are both arranged between the driving wheel and driven wheel, the distance between the first barrier and the driving wheel is L1, and 0<L1<5 mm; the distance between the second barrier and the driven wheel is L2, and 0<L2<5 mm.

### PRIORITY

The present application is a Continuation application of PCT Application No. PCT/CN2023/136800 filed on Dec. 6, 2023, which claims priority to Chinese Patent Application No. 202321348579.1, filed on May 30, 2023, and claims priority to Chinese Patent Application No. 202321990435.6, filed on Jul. 26, 2023, the contents of which are incorporated herein by reference in their entirety.

### TECHNICAL FIELD

The application relates to the technical field of mobile devices, in particular to a crawler and snow sweeping equipment.

### BACKGROUND

During the working process of the traveling mechanism, impurities like rain, snow, sand, and so forth enter the crawler from the outside and adhere to the pulley's outer ring, increasing the pulley's diameter and tightening the crawler. This increases friction between the pulley and the crawler during operation and makes the traveling motor more likely to experience frequent overcurrent.

### SUMMARY OF THE INVENTION

In view of this, the embodiment of the application provides a crawler and a snow sweeping equipment, aiming at addressing the inadequacies of the prior art.

The embodiment of the application provides a crawler, which includes a crawler body, a driving wheel, a driven wheel, a first frame body, a second frame body, a first barrier and a second barrier. The driving wheel and the driven wheel are respectively arranged at two ends of the inner side of the crawler body for driving connection through the crawler body. The first frame body and the second frame body are respectively arranged at two opposite sides of the axis direction of the driving wheel, so that the driving wheel and the driven wheel are connected. The first barrier and the second barrier are both arranged between the driving wheel and the driven wheel, and the distance between the first barrier and the driving wheel is L1, and 0<L1<5 mm; the distance between the second barrier and the driven wheel is L2, and 0<L2<5 mm.

The embodiment of the application provides a crawler, which includes a frame, a first wheel, a second wheel and a snow scraping component. The frame includes a first frame body and a second frame body. The first wheel and the second wheel are rotatably connected to the frame respectively, and the first wheel and the second wheel are opposite to each other and arranged at intervals; one of the first wheel and the second wheel is a driving wheel, and another is a driven wheel; a crawler body is sleeved on a periphery of the first wheel and a periphery of the second wheel, and the crawler body is engaged with the first wheel and the second wheel. The snow scraping component is at least a part of a first barrier and a second barrier, the snow scraping component is connected to the frame and positioned between the first wheel and the second wheel, and the snow scraping component has a gap “d” with an outer wheel face of the first wheel.

The embodiment of the application also provides a snow sweeping equipment, which includes a self-moving device and a snow removal device. The self-moving device includes the crawler provided by any of the above embodiments, and the snow removal device is installed on the self-moving device.

The embodiment of the invention has the following advantages. The first barrier and the second barrier are arranged between the driving wheel and the driven wheel. The distance between the first barrier and the driving wheel is adjusted. This improves the blocking efficiency and quality of the first barrier to impurities attached to the face of the driving wheel, while also preventing silt, snow, or other impurities from attaching to the face of the driving wheel, improving the driving wheel's fluency in the rotation process. Meanwhile, the distance between the second barrier and the driven wheel is adjusted. This improves the blocking efficiency and quality of the second barrier to impurities attached to the face of the driven wheel, while also preventing silt, snow or other impurities from attaching to the face of the driven wheel, improving the driven wheel's fluency in the rotation process. In this way, the stability and fluency of the crawler in the moving process are enhanced.

To make the above-mentioned purposes, features, and advantages of the embodiments of this application more evident and understandable, several embodiments are provided below and described in detail with the attached drawings.

### BRIEF DESCRIPTION OF THE DRAWINGS

In order to explain the technical solution of the embodiments of this application more clearly, the drawings described in the description of the embodiments of this application will be briefly introduced below. Obviously, the drawings in the present application and their accompanying detailed description are directed to merely exemplary embodiments of the application. For those of ordinary skill in this field, other drawings may be obtained according to these drawings without any creative effort.

FIG. 1 is a structural schematic diagram of a crawler from a perspective provided by an embodiment of the present application.

FIG. 2 is an explosive view of a crawler provided by an embodiment of the application

FIG. 3 is a schematic diagram of partial structure of a crawler provided by an embodiment of the present application.

FIG. 4 is an enlarged view of part A shown in FIG. 3.

FIG. 5 is a structural schematic diagram of a crawler provided by another embodiment of the present application.

FIG. 6 is a partially enlarged diagram of the position of a first wheel of a crawler provided by another embodiment of the present application.

Reference signs in the drawings are as follows.
1000—Crawler; 100—Crawler body; 200—Driving wheel; 210—Rim face of the driving wheel; 220—Rim of the driving wheel; 230—First wheel; 231—Outer wheel face; 300—Driven wheel; 310—Rim face of the driven wheel; 320—Rim of the driven wheel; 330—Second wheel; 400—First frame body; 500—Second frame body; 600—First barrier; 610—Snow scraping part; 620—Snow blocking part; 700—Second barrier; 800—Driving mechanism; 810—Encoder; 900—Connector; 910—First gasket; 920—Second gasket; 930—Snow guiding member; 9301—Snow guiding face; 940—Protrusion structure; 950—Snow scraping component; 960—Frame.

### DETAILED DESCRIPTION OF PREFERRED EMBODIMENTS

In order to provide a better understanding for those skilled in the art, the technical solutions in the embodiments of the present application will be clearly and completely described below with reference to the drawings in the embodiments of this application. Obviously, the described embodiments are merely part of the embodiments of this application, not all of them. Based on the embodiments in this application, all other embodiments obtained by those of ordinary skill in the art without creative effort belong to the protection scope of this application.

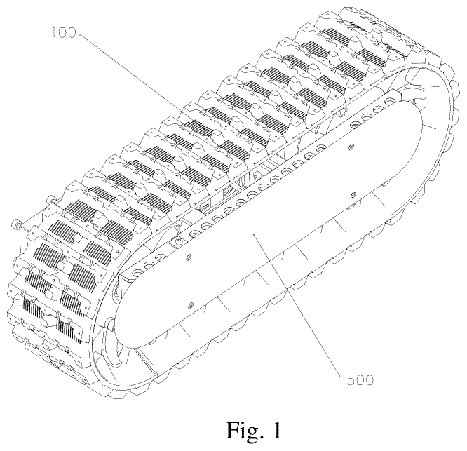

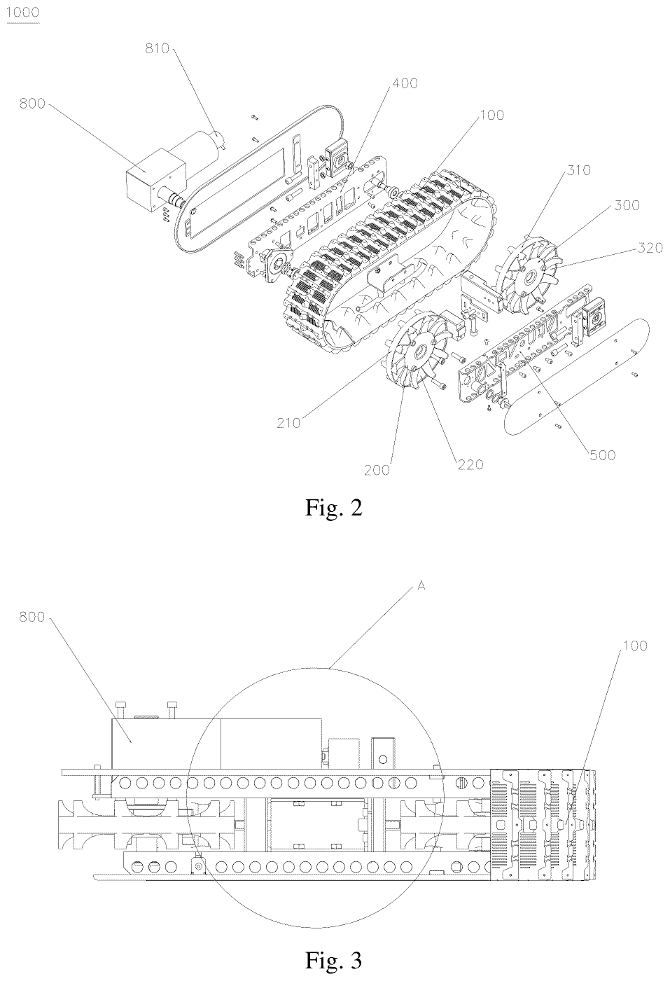

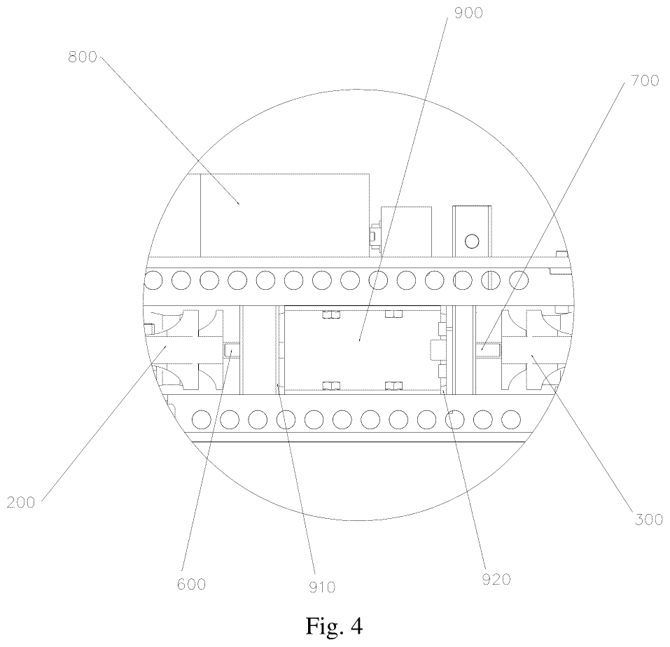

As shown in FIG. 1, FIG. 2 and FIG. 4, the embodiment of the application provides a crawler 1000, which is mainly applied to a crawler vehicle. With the crawler 1000, the contact area and friction between the crawler 1000 and the ground can be improved during the walking of the crawler vehicle, thus preventing the crawler vehicle from slipping, loosening or falling down during the walking. This enhances the stability of the crawler vehicle during the walking.

The crawler 1000 includes a crawler body 100, a driving wheel 200 and a driven wheel 300. The driving wheel 200 and driven wheel 300 are respectively arranged at two ends of the inner side of the crawler body 100, For example, the crawler body 100 can be sleeved on the peripheries of the driving wheel 200 and the driven wheel 300, and the crawler body 100 can be engaged with the driving wheel 200 and the driven wheel 300, so that the driving wheel 200 and the driven wheel 300 are drivingly connected through the crawler body 100.

The crawler body 100 may be made of rubber, polyurethane or other suitable materials to ensure wear resistance, crack resistance and good elastic properties. The design and size of the crawler body 100 should be matched with the driving wheel 200 and driven wheel 300 to ensure good meshing and smooth driving. Meanwhile, the texture and structure of the crawler body 100 can be optimized according to different use environments and requirements for better grip and traction.

It should be noted that the driving wheel 200 and the driven wheel 300 are respectively arranged at two opposite sides in the walking direction of the crawler body 100. That is, the crawler body 100 can be spread by the driving wheel 200 and the driven wheel 300 to keep the crawler body 100 in a tightened state.

In some embodiments, the crawler body 100 further includes a first frame body 400 and a second frame body 500, which are respectively arranged at two opposite sides of the axis direction of the driving wheel 200; the driving wheel 200 and the driven wheel 300 are connected through the first frame body 400 and the second frame body 500, and the driving wheel 200 is rotatably connected to the first frame body 400 and the second frame body 500. This enables the driving wheel 200 to rotate along its own axis, and the driven wheel 300 is rotatably connected to the first frame body 400 and the second frame body 500, so that the driven wheel 300 can rotate along its own axis.

It can be understood that the driving wheel 200 and the driven wheel 300 can be fixed through the first frame body 400 and the second frame body 500, so that the distance between the axis of the driving wheel 200 and the axis of the driven wheel 300 can be kept constant, and the stability of the driving wheel 200 and the driven wheel 300 in the rotation process can be improved.

It should be noted that the first frame body 400 and the second frame body 500 are connected so that the driving wheel 200 and the driven wheel 300 can be restricted through the first frame body 400 and the second frame body 500. This improves the stability of the driving wheel 200 and the driven wheel 300 at the inner side of the crawler body 100, as well as the stability of the crawler 1000 while walking.

Illustratively, the first frame body 400 and the second frame body 500 are symmetrically arranged inside the crawler body 100, and both the first frame body 400 and the second frame body 500 have gaps with the rim 220 of the driving wheel 200 and the rim 320 of the driven wheel 300.

Furthermore, the crawler body 100 further includes a first barrier 600 and a second barrier 700, both of which are arranged between the driven wheel 300 and the driving wheel 200. In this way, the first barrier 600 can have a blocking effect on the impurities attached to the rim face 210 of the driving wheel 200, and the second barrier 700 can have a blocking effect on the impurities attached to the rim face 310 of the driven wheel 300, thus improving the stability and fluency of the driving wheel 200 and the driven wheel 300 during rotation.

It can be understood that the blocking effect may mean that the first barrier 600 scrapes off the impurities attached to the rim face 210 of the driving wheel 200, and the second barrier 700 scrapes off the impurities attached to the rim face 310 of the driven wheel 300. The blocking effect may also mean that the first barrier 600 and the second barrier 700 separate out impurities, preventing them from sticking to the rim face 210 of the driving wheel 200 and rim face 310 of the driven wheel 300.

In some embodiments, the first barrier 600 is arranged close to the driving wheel 200, and the first barrier 600 is connected to the first frame body 400 and/or the second frame body 500 to improve the stability of the first barrier 600.

In some embodiments, the distance between the first barrier 600 and the driving wheel 200 is L1, and 0<L1<5 mm. The range of L1 values includes: 0<L1<0.5 mm, 0<L1<1.5 mm, 0<L1<2 mm, 0<L1<2.5 mm, 0<L1<3 mm, 0<L1<3.5 mm, 0<L1<4 mm, 0<L1<4.5 mm, 0<L1<5 mm, 0.5<L1<5 mm, 1<L1<5 mm, 1.5<L1<5 mm, 2<L1<5 mm, 2.5<L1<5 mm, 3<L1<5 mm, 3.5<L1<5 mm, 4<L1<5 mm and 4.5<L1<5 mm.

It should be noted that by arranging a gap between the first barrier 600 and the driving wheel 200, the friction generated between the driving wheel 200 and the first barrier 600 can be prevented from affecting the fluency of the driving wheel 200 during rotation.

Further, by adjusting the distance between the first barrier 600 and the driving wheel 200, the blocking efficiency and blocking quality of the first barrier 600 to impurities attached to the face of the driving wheel 200 can be improved, and silt, snow or other impurities can be prevented from attaching to the face of the driving wheel 200. This improves the fluency of the driving wheel 200 in the rotating process, and also helps to reduce the risk that the first barrier 600 interferes with the driving wheel 200, thereby ensuring the safe operation of the driving wheel 200.

In some embodiments, the distance between the second barrier 700 and the driven wheel 300 is L2, and 0<L2<5 mm. The range of L2 values includes: 0<L2<0.5 mm, 0<L2<1.5 mm, 0<L2<2 mm, 0<L2<2.5 mm, 0<L2<3 mm, 0<L2<3.5 mm, 0<L2<4 mm, 0<L2<4.5 mm, 0<L2<5 mm, 0.5<L2<5 mm, 1<L2<5 mm, 1.5<L2<5 mm, 2<L2<5 mm, 2.5<L2<5 mm, 3<L2<5 mm, 3.5<L2<5 mm, 4<L2<5 mm and 4.5<L2<5 mm.

It can be understood that by arranging a gap between the second barrier 700 and the driven wheel 300, the friction generated between the driven wheel 300 and the second barrier 700 can be prevented from affecting the fluency of the driven wheel 300 during rotation.

Further, by adjusting the distance between the second barrier 700 and the driven wheel 300, the blocking efficiency and blocking quality of the second barrier 700 to impurities attached to the face of the driven wheel 300 can be improved, and silt, snow or other impurities can be prevented from attaching to the face of the driven wheel 300. This improves the fluency of the driven wheel 300 in the rotating process, and also helps to reduce the risk that the second barrier 700 interferes with the driven wheel 300, thereby ensuring the safe operation of the driven wheel 300.

Therefore, by arranging the first barrier 600 and the second barrier 700, not only can silt, snow or other external impurities be prevented from adhering to the driving wheel 200 and the driven wheel 300 during the rotation of the driving wheel 200 and the driven wheel 300, but also the stability and fluency of the crawler 1000 during the walking process can be improved.

In some embodiments, the value range of L1 is 0.5 mm≤L1≤1.5 mm. It can be understood that the range of L1 may be: 0.5 mm≤L1≤1.5 mm, 0.6 mm≤L1≤1.5 mm, 0.7 mm≤L1≤1.5 mm, 0.8 mm≤L1≤1.5 mm, 0.9 mm≤L1≤1.5 mm, 1 mm≤L1≤1.5 mm, 1.1 mm≤L1≤1.5 mm, 1.2 mm≤L1≤1.5 mm, 1.3 mm≤L1≤1.5 mm and 1.4 mm≤L1≤1.5 mm.

In this way, by lowering the distance between the first barrier 600 and the driving wheel 200, the thickness of impurities attached to the rim face 210 of the driving wheel 200 can be reduced. Meanwhile, the snow or frozen ice on the rim face 210 of the driving wheel 200 can be scraped off by the first barrier 600, thus improving the stability of the driving wheel 200 during operation.

In some embodiments, the value range of L2 is 0.5 mm≤L2≤1.5 mm. It can be understood that the range of L2 may be: 0.5 mm≤L2≤1.5 mm, 0.6 mm≤L2≤1.5 mm, 0.7 mm≤L2≤1.5 mm, 0.8 mm≤L2≤1.5 mm, 0.9 mm≤L2≤1.5 mm, 1 mm≤L2≤1.5 mm, 1.1 mm≤L2≤1.5 mm, 1.2 mm≤L2≤1.5 mm, 1.3 mm≤L2≤1.5 mm, 1.4 mm≤L2≤1.5 mm.

In this way, by lowering the distance between the second barrier 700 and the driven wheel 300, the thickness of impurities attached to the rim face 310 of the driven wheel 300 can be reduced. Meanwhile, the snow or frozen ice on the rim face 310 of the driven wheel 300 can be scraped off by the second barrier 700, thus improving the stability of the driven wheel 300 during operation. This improves the stability of the crawler during movement.

As shown in FIG. 2 and FIG. 3, in some embodiments, the crawler body 100 further includes a driving mechanism 800, which is arranged on one side of the first frame body 400 close to the driving wheel 200. And the driving mechanism 800 is positioned at the side of the first frame body 400 away from the driving wheel 200, and the driving mechanism 800 is connected to the first frame body 400 by bolts. This facilitates the assembly or disassembly of the driving mechanism 800 on the first frame body 400 and improves the stability of the driving mechanism 800 on the first frame body 400.

In addition, the first barrier 600 can be used to scrape off the snow or impurities attached to the rim face 210 of the driving wheel 200, thus reducing the friction between the crawler body 100 and the snow or impurities, and preventing the driving mechanism 800 from being overloaded, overheated or even burned.

In some embodiments, the driving mechanism 800 is a walking motor.

Illustratively, the output end of the driving mechanism 800 penetrates through the first frame body 400 to connect with the driving wheel 200, so as to control the driving wheel 200 to rotate through the output end of the driving mechanism 800.

It should be noted that the axis of the driving wheel 200 coincides with the axis of the output end of the driving mechanism 800. That is, when the driving mechanism 800 is started, the output end of the driving mechanism 800 can drive the driving wheel 200 to rotate coaxially during rotation.

In some embodiments, one side of the output end of the driving mechanism 800 is provided with an encoder 810 for recording the walking distance of the crawler 1000.

As shown in FIGS. 2 and 3, in some embodiments, the first frame body 400 and the second frame body 500 are connected through a connector 900. This improves the stability of the first frame body 400 and the second frame body 500 inside the crawler body 100.

The connection mode between the connector 900 and the first frame body 400/second frame body 500 includes any one of bolting, clamping and welding. For example, both the first frame body 400 and the second frame body 500 are connected to the connector 900 by bolts for easy assembly or disassembly.

Illustratively, one end of the connector 900 is connected to the first frame body 400 and the other end of the connector 900 is connected to the second frame body 500. By arranging the connector 900 between the first frame body 400 and the second frame body 500, not only can the first frame body 400 and the second frame body 500 be connected, but also the distance between the first frame body 400 and the second frame body 500 can be kept stable. Therefore, the stability of the driving wheel 200 and the driven wheel 300 during rotation is improved, and contact with the first frame body 400 and the second frame body 500 is avoided.

It should be noted that in some embodiments, the connector 900 is any one or a combination of two or more of a connecting rod, a connecting plate, a connecting table and a connecting buckle.

Further, the connector 900 is positioned between the driving wheel 200 and the driven wheel 300. There is a gap between the connector 900 and the driving wheel 200, and there is a gap between the connector 900 and the driven wheel 300. This prevents the driving wheel 200 and the driven wheel 300 from contacting with the connector 900 during rotation, and to ensure the stability of the driving wheel 200 and the driven wheel 300 during rotation.

As shown in FIGS. 3 and 4, in some embodiments, the first barrier 600 is close to the driving wheel 200 to block impurities on the face of the driving wheel 200 by the first barrier 600, and the second barrier 700 is close to the driven wheel 300 to block impurities on the face of the driven wheel 300 by the second barrier 700. This can keep the faces of the hub of the driving wheel 200 and the hub of the driven wheel 300 clean.

Illustratively, the first barrier 600 at least partially covers the rim 220 of the driving wheel 200 along the first direction. That is, the first barrier 600 partially covers the rim 220 of the driving wheel 200, or the first barrier 600 completely covers the rim 220 of the driving wheel 200.

It should be noted that the first direction is the perpendicular direction from one end of the first barrier 600 facing the driving wheel 200 to the axis of the driving wheel 200.

In some embodiments, the second barrier 700 at least partially covers the rim 320 of the driven wheel 300 along the second direction. That is, the second barrier 700 partially covers the rim 320 of the driven wheel 300, or the second barrier 700 completely covers the rim 320 of the driven wheel 300.

Moreover, the second direction is the perpendicular direction from an end of the second barrier 700 facing the driven wheel 300 to the axis of the driven wheel 300.

Further, the relationship between the first direction and the second direction may be parallel or intersecting.

In some embodiments, the first barrier 600 completely covers the rim 220 of the driving wheel 200 along the first direction. The second barrier 700 completely covers the rim 320 of the driven wheel 300 in the second direction. In this way, during the rotation of the driving wheel 200 and the driven wheel 300, the first barrier 600 can completely block the impurities attached to the rim face 210 of the driving wheel 200, so as to improve the blocking quality of the first barrier 600. Meanwhile, the second barrier 700 can completely block the impurities attached to the rim face 310 of the driven wheel 300, so as to improve the blocking quality of the second barrier 700.

As shown in FIG. 4, in some embodiments, the first barrier 600 is a first bolt, one end of the first bolt is screwed with the connector 900, and the other end of the first bolt faces the driving wheel 200.

It should be noted that by adopting the first bolt as the first barrier 600, the first bolt can form a threaded connection with the connector 900. That is, by rotating the first barrier 600 to adjust the distance between the first barrier 600 and the connector 900. Meanwhile, the distance between the first barrier 600 and the rim 220 of the driving wheel 200 can be adjusted. In this way, while the driving wheel 200 is prevented from making contact with the first barrier 600 during rotation, the first barrier 600 can block the impurities attached to the rim surface 210 of the driving wheel 200, thereby improving the stability and fluency of the driving wheel 200 during rotation.

In some embodiments, the second barrier 700 is a second bolt, and one end of the second bolt is screwed with the connector 900, and the other end of the second bolt faces the driven wheel 300.

It should be noted that by adopting the second bolt as the second barrier 700, the second bolt can form a threaded connection with the connector 900. That is, by rotating the second barrier 700 to adjust the distance between the second barrier 700 and the connector 900. Meanwhile, the distance between the second barrier 700 and the rim 320 of the driven wheel 300 can be adjusted. In this way, while the driven wheel 300 is prevented from making contact with the second barrier 700 during rotation, the second barrier 700 can block the impurities attached to the rim surface 310 of the driven wheel 300, thereby improving the stability and fluency of the driven wheel 300 during rotation. This enhances the stability and fluency of the crawler during movement.

In some embodiments, a first gasket 910 is provided between the first barrier 600 and the connector 900. The number of the first gasket 910 can be 1, 2, or more, according on the circumstances.

Illustratively, the first barrier 600 passes through the first gasket 910 and is connected to the connector 900. It can be understood that the arrangement of the first gasket 910 between the first barrier 600 and the connector 900 allows for the adjustment of the distance between the first barrier 600 and the driving wheel 200. That is, the distance between the first barrier 600 and the driving wheel 200 can be adjusted by modifying the number of the first gasket 910.

It should be noted that the thickness of the first gasket 910 is L3, where the value range of L3 is 0.1 mm≤L3<0.5 mm. It can be understood that the range of L3 may be: 0.1 mm≤L3≤0.5 mm, 0.1 mm≤L3<0.4 mm, 0.1 mm≤L3≤0.3 mm, 0.1 mm≤L3<0.2 mm, 0.1 mm≤L3≤0.15 mm, 0.15 mm≤L3<0.5 mm, 0.2 mm≤L3≤0.5 mm, 0.3 mm≤L3≤0.5 mm and 0.4 mm≤L3<0.5 mm.

In some embodiments, a second gasket 920 is provided between the second barrier 700 and the connector 900. The number of the second gasket 920 can be 1, 2, or more, according on the circumstances.

For example, the second barrier 700 penetrates the second gasket 920 and is connected to the connector 900. It can be understood that the arrangement of the second gasket 920 between the second barrier 700 and the connector 900 allows for the adjustment of the distance between the second barrier 700 and the driven wheel 300. That is, the distance between the second barrier 700 and the driven wheel 300 can be adjusted by modifying the number of the second gasket 920.

It should be noted that the thickness of the first gasket 910 is L4, where the value range of L4 is 0.1 mm≤L430.5 mm. It can be understood that the range of L4 may be: 0.1 mm≤L4≤0.5 mm, 0.1 mm≤L4<0.4 mm, 0.1 mm≤L4≤0.3 mm, 0.1 mm≤L4≤0.2 mm, 0.1 mm≤L4≤0.15 mm, 0.15 mm≤L4≤0.5 mm, 0.2 mm≤L4≤0.5 mm, 0.3 mm≤L4≤0.5 mm and 0.4 mm≤L4<0.5 mm.

Further, in order to improve the stability and compressive strength of the first gasket 910 and the second gasket 920, in this embodiment, both the first gasket 910 and the second gasket 920 are metal gaskets.

In some embodiments, both the first barrier 600 and the second barrier 700 are telescopic rods.

Illustratively, the first barrier 600 is a first telescopic rod and the second barrier 700 is a second telescopic rod. By adjusting the length of the first telescopic rod, the distance between the first barrier 600 and the driving wheel 200 can be adjusted. By adjusting the length of the second telescopic rod, the distance between the first barrier 600 and the driving wheel 200 can be adjusted. In this way, the impurities on the face of the driving wheel 200 is blocked by the first telescopic rod, and the impurities on the face of the driven wheel 300 is blocked by the second telescopic rod, thus improving the stability and fluency of the crawler 1000 in the moving process.

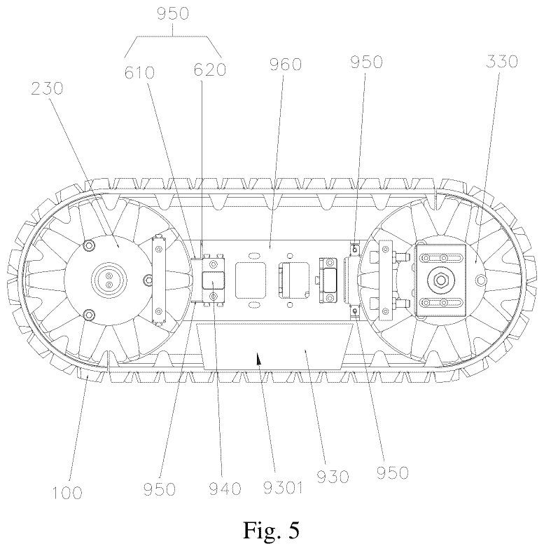

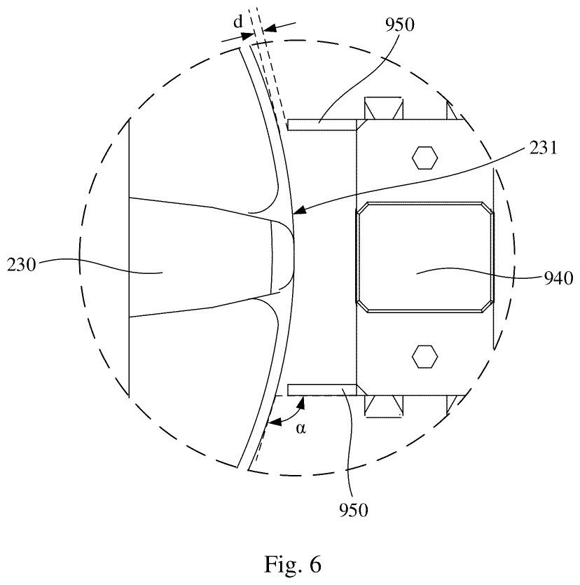

Referring to FIGS. 5 and 6, the embodiment of the present application further provides a crawler 1000, which may include a frame 960, a first wheel 230, a second wheel 330 and a snow scraping component 950, and the frame 960 includes a first frame body 400 and a second frame body 500.

In some embodiments, the first wheel 230 and the second wheel 330 are rotatably connected to the frame 960, respectively, and the first wheel 230 and the second wheel 330 can be arranged oppositely and at intervals, and one of the first wheel 230 and the second wheel 330 may be the driving wheel 200 and the other may be the driven wheel 300. The driving wheel 200 is the driver wheel.

The crawler body 100 can be sleeved on the periphery of the first wheel 230 and the periphery of the second wheel 330, and the crawler body 100 can be engaged with the first wheel 230 and the second wheel 330. The snow scraping component 950 may be connected to the frame 960 and positioned between the first wheel 230 and the second wheel 330, and the snow scraping component 950 may have a gap “d” with the outer wheel face 231 of the first wheel 230 (see FIG. 6).

In this way, the snow scraping component 950 can be used to scrape off the snow or impurities attached to the outer wheel face 231 of the first wheel 230. This reduces the risk of irreversible deformation of the crawler body 100 caused by snow or impurities attached to the outer wheel face 231 of the first wheel 230, avoids loosening of the crawler body 100, prolongs the service life of the crawler body 100, and keeps the crawler body 100 fastened and in normal working condition. Therefore, the crawler 1000 can be driven normally. And the snow scraping component 950 is positioned between the first wheel 230 and the second wheel 330, which can reduce the risk of interfering with the crawler body 100. The outer wheel face 231 of the first wheel 230 is the rim face 210 of the driving wheel 200.

Furthermore, the crawler 1000 has the advantages of a simple structure and reliable operation, making it suitable for use in a variety of devices that require driving on snow, ice, or other sliding surfaces, with good driving performance and snow scraping effect.

The gap “d” between the snow scraping component 950 and the outer wheel face 231 of the first wheel 230 refers to the distance between the snow scraping component 950 and the outer wheel face 231 of the first wheel 230. The gap “d” can ensure that the snow scraping component 950 can effectively contact with the snow or debris attached to the outer wheel face 231 of the first wheel 230, and scrape it off.

The gap “d” should not be too large, so as to ensure that the snow scraping component 950 can scrape off the snow or debris attached to the outer wheel face 231 of the first wheel 230, and reduce the risk of snow or debris attached to the outer wheel face 231 of the first wheel 230. In this way, the snow scraping component 950 can give full play to its scraping function and improve the effect of removing snow or debris attached to the outer wheel face 231 of the first wheel 230. Moreover, the gap “d” can also reduce the risk of mutual abrasion between the outer wheel face 231 of the first wheel 230 and the snow scraping component 950.

The size of the gap “d” also allows the first wheel 230 to move smoothly. If the the gap “d” is too small, the first wheel 230 may become stuck in motion and unable to operate normally. Therefore, on the premise of ensuring that the snow scraping component 950 is in contact with the snow or impurities attached to the outer wheel face 231 of the first wheel 230, it is necessary to leave a proper space to accommodate the movement and work of the first wheel 230.

The gap “d” is usually realized by the design and position of the snow scraping component 950. According to the actual demand, the size of the gap “d” can be controlled by the size, shape and installation position of the snow scraping component 950 installed on the frame 960.

As a basic structure of the whole crawler 1000, the frame 960 carries and fixes other components, such as the first wheel 230, second wheel 330, crawler body 100 and snow scraping component 950. With appropriate design of the structure and assembly mode of the frame 960, it can be ensured that all parts are connected safely and stably, and can bear the load transmitted from all parts.

The first wheel 230 is usually driven by a power device such as a motor to generate enough rotational torque to drive the whole crawler 1000 to run. The second wheel 330 receives the power transmitted by the first wheel 230 and converts it into the traction force of the crawler body 100 by engaging with the first wheel 230 or the crawler body 100. In this way, the snow scraping component 950 can be used to scrape off the snow or impurities attached to the outer wheel face 231 of the first wheel 230, thus reducing the friction between the crawler body 100 and the snow or impurities, and preventing the motor and other power devices from being overloaded, overheated or even burned.

The snow scraping component 950 can be installed on the frame 960 by inserting, screwing or bolting. The snow scraping component 950 is usually made of high-strength metal materials, such as steel or aluminum alloy, which makes snow scraping component 950 better resist the pressure and friction of snow or debris attached to the outer wheel face 231 of the first wheel 230 and provide better a scraping effect.

The snow scraping component 950 may be a plate-like snow scraping component, which usually has a large width and length and can provide a large contact area when contacting with the first wheel 230. In this way, the effective scraping area can be increased, and the snow scraping component 950 can better remove the snow or impurities attached to the outer wheel face 231 of the first wheel 230 in a wide range.

In other embodiments, the snow scraping component 950 may also be a sawtooth-shaped snow scraping component, and the edge of the sawtooth-shaped snow scraping component may be serrated, similar to a jagged shape. This design can increase the friction and cutting force between the snow scraping component 950 and the outer wheel face 231 of the first wheel 230, and improve the scraping effect. The sawtooth-shaped snow scraping component can be used for removing stubborn or solidified snow or impurities attached to the outer wheel face 231 of the first wheel 230. This provides a better cutting and cleaning effect.

In some embodiments, the gap “d” is 0.3 mm-1.5 mm. For example, the gap “d” may be 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm and etc. This allows the snow and impurities attached to the outer wheel face 231 of the first wheel 230 to be scraped effectively within this range, improves the removal effect of the snow and impurities attached to the outer wheel face 231 of the first wheel 230, and reduces the risk of the snow scraping component 950 interfering with the first wheel 230, thus ensuring the safe operation of the first wheel 230.

In some embodiments, the gap “d” is 0.5 mm-1.2 mm. For example, the gap “d” may be 0.5 mm, 0.6 mm, 0.7 mm, 0.8 mm, 0.9 mm, 1.0 mm, 1.1 mm, 1.2 mm and etc. This allows the snow and impurities attached to the outer wheel face 231 of the first wheel 230 to be scraped more effectively within this range, improves the removal effect of the snow and impurities attached to the outer wheel face 231 of the first wheel 230, and reduces the risk of the snow scraping component 950 interfering with the first wheel 230, thus effectively ensuring the safe operation of the first wheel 230.

In some embodiments, the projection of the first wheel 230 toward the snow scraping component 950 may locate between the two ends of the snow scraping component 950.

Specifically, the outer wheel face 231 of the first wheel 230 is projected in the direction of the snow scraping component 950. The projection of the outer wheel face 231 of the first wheel 230 falls between the two ends of the snow scraping component 950, allowing the length of the snow scraping component 950 to completely cover the width of the out wheel face 231 of the first wheel 230, thereby effectively removing the snow or impurities attached to the out wheel face 231 of the first wheel 230.

In some embodiments, the included angle “a” formed by the tangent of the outer wheel face 231 of the first wheel 230 and the plane where the snow scraping component 950 is located is an obtuse angle. The tangent of the outer wheel face 231 of the first wheel 230 refers to the intersection of the outer wheel face 231 of the first wheel 230 and the plane where the snow scraping component 950 is located along the rotation direction of the first wheel 230 (when the snow scraping component 950 is positioned above the wheel center of the first wheel 230, the counterclockwise rotation direction of the first wheel 230 shall prevail. As shown in FIG. 6, when the snow scraping component 950 is positioned below the first wheel 230, the clockwise rotation direction of the first wheel 230 shall prevail.) FIG. 6 shows the tangent line. Specifically, a larger angle is formed between the plane of snow scraping component 950 and the outer wheel face 231 of the first wheel 230, which is helpful to improve the contact effect between the snow scraping component 950 and first wheel 230 and improve the snow scraping performance of the snow scraping component 950.

In some embodiments, the length direction of the snow scraping component 950 is consistent with the axial direction of the first wheel 230. Specifically, the longitudinal direction of the snow scraping component 950 may be parallel to the axial direction of the first wheel 230. Alternatively, the longitudinal direction of the snow scraping component 950 may be approximately parallel to the axial direction of the first wheel 230. In this way, the snow scraping component 950 can scrape off the snow or impurities attached to the outer wheel face 231 of the first wheel 230 roughly along the axial direction of the first wheel 230. Therefore, the snow scraping component 950 can fully remove the snow and impurities attached to the outer wheel face 231 of the first wheel 230, and improve the stability and reliability of the crawler body 100 when driving in the snow. Moreover, the axial direction of the snow scraping component 950 is consistent with that of the first wheel 230, so that the snow scraping component 950 is subjected to more uniform force distribution in the working process. This is helpful to reduce the uneven stress and vibration of the snow scraping component 950, reduce the wear and damage of the snow scraping component 950, and thus prolong the service life of the snow scraping component 950.

In some embodiments, the snow scraping component 950 may be disposed obliquely downward from the frame 960. Specifically, when the snow scraping component 950 contacts with the crawler body 100 and removes snow or debris. The incline arrangement of the snow scraping component 950 can guide the snow or debris attached to the outer wheel face 231 of the first wheel 230 to the edge of the crawler body 100, so that the snow or debris can overflow from the outer side of the crawl body 100, thereby reducing the accumulation of snow or debris in the crawler body 100. In addition, the incline arrangement of the snow scraping component 950 is helpful to remove the snow or debris scraped from the outer wheel face 231 of the first wheel 230 from the snow scraping component 950, so that the snow or debris on the snow scraping component 950 can easily slide down and be discharged from the working area of the snow scraping component 950. This can reduce the risk of accumulation of snow or impurities scraped from the outer wheel face 231 of the first wheel 230 on the snow scraping component 950, and improve the self-cleaning effect of the snow scraping component 950.

Referring to FIG. 5, in some embodiments, the snow scraping component 950 may include a snow scraping part 610 and a snow blocking part 620 which are connected. One of the snow scraping part 610 and snow blocking part 620 can be connected to the frame 960, and the snow blocking part 620 extends upward from the side of the snow scraping part 610 away from the first wheel 230. In this way, the snow blocking part 620 can reduce the risk that the snow or impurities scraped by the snow scraping part 610 from the outer wheel face 231 of the first wheel 230 splash into the crawler body 100. This can reduce the influence of the crawler body 100 on the accumulation of snow or impurities scraped from the outer wheel face 231 of the first wheel 230, and maintain the normal operation and stable performance of the crawler body 100.

In some embodiments, the crawler 1000 may further include a snow guiding member 930 connected to the frame 960, and the snow guiding member 930 may have a snow guiding face 9301. The snow guiding face 9301 inclines downward from the frame 960 in a direction away from the frame 960.

The snow guiding member 930 may be a snow guide plate or a snow guide block. The snow guiding member 930 can usually be connected to the frame 960 in various forms. The snow guiding member 930 is usually designed in the shape of a reserved mounting hole or a fixing seat to match the mounting position of the frame 960, and it is firmly connected to the frame 960 by bolts or other fixing devices.

In this way, the downward inclination of snow guiding face 9301 can allow the snow or impurities scraped by the snow scraping component 950 from outer wheel face 231 of first wheel 230 to be directed away from frame 960, thus decreasing the accumulation of snow or impurities scraped from the outer wheel face 231 of the first wheel 230 on the crawler body 100, and reducing the interference to the crawler 1000. In addition, the snow guiding face 9301 may also reduce the load on crawler body 100 caused by snow or impurities scraped from the outer wheel face 231 of the first wheel 230. Because of the inclination of snow guiding face 9301, the snow or impurities scraped from the outer wheel face 231 of the first wheel 230 are more easily guided to the edge of the crawler body 100, which lowers the risk that the snow or impurities scraped from the outer wheel face 231 of first wheel 230 are squeezed inside crawler body 100 and reduces the load on crawler body 100. This helps to reduce the burden of the crawler body 100 and improve the performance and stability of the crawler body 1000 when driving in snow.

In some embodiments, the frame 960 may have a protrusion structure 940. The protrusion structure 940 is a structure in which the frame 960 cooperates with other components. The protrusion structure 940 is positioned between the first wheel 230 and the second wheel 330 at intervals, and the snow scraping component 950 is connected to the upper and lower sides of the protrusion structure 940. In this way, the snow scraping component 950 is tightly connected to the protrusion structure 940, which can resist the force generated in the snow scraping process, lower the possibility that the component will shift or fall off, and guarantee the stability of the snow scraping component 950.

In addition, since the snow scraping components 950 are connected to the upper and lower sides of the protrusion structure 940, for example, a plurality of snow scraping components 950 may be arranged on both sides of the connecting line between the two wheels (first wheel 230 and second wheel 330). Therefore, the snow scraping component 950 can adapt to the forward and reverse rotation of first wheel 230. The snow scraping component 950 can quickly and effectively scrape off the snow or impurities attached to the outer wheel face 231 of first wheel 230, making the snow scraping performance of snow scraping component 950 more comprehensive and reliable under various working conditions. Moreover, it also decreases snow or impurities scraped from the outer wheel face 231 of the first wheel 230 that accumulate between the space of the protrusion structure 940 and the first wheel 230, ensuring that the first wheel 230 runs stably.

In some embodiments, the second wheel 330 may also be provided with an outer wheel face 231, the positional relationship between the snow scraping component 950 and outer wheel face 231 of the second wheel 330 can be designed according to the installation position between first wheel 230 and snow scraping component 950. This lowers the possibility that the snow or impurities from the second wheel 330 will cause irreversible deformation of the crawler body 100, prevents the crawler body 100 from loosening, extends the service life of the crawler body 100, and keeps the crawler body 100 fastened and in normal operating condition so that the crawler body 1000 can drive normally. The outer wheel face 231 of the second wheel 330 is the rim face 310 of the driven wheel 300.

In some embodiments, the crawler 1000 may further include a plurality of snow scraping component sets, and each snow scraping component set includes a plurality of snow scraping components 950, and the number of snow scraping components 950 in each snow scraping component set may be different.

The first wheel 230 and the second wheel 330 are respectively provided with a snow scraping component set. A plurality of the snow scraping components 950 corresponding to the first wheel 230 are arranged on both sides of the connecting line between the wheel centers of the first wheel 230 and the second wheel 330. A plurality of the snow scraping component 950 corresponding to the second wheel 330 are arranged on both sides of the connecting line between the wheel centers of the first wheel 230 and the second wheel 330. In this way, regardless of whether the crawler 1000 drives forward or backward, the snow scraping component set may effectively scrape off the snow or impurities from the outer wheel face 231 of the first wheel 230 and the outer wheel face 231 of the second wheel 330.

The wheel center of the first wheel 230 may be the rotation center of the first wheel 230, and the wheel center of the second wheel 330 may be the rotation center of the second wheel 330.

The embodiment of the application further provides a snow sweeping equipment, which includes a snow removal device and a self-moving device, and the self-moving device can be connected to the snow removal device, so as to carry the snow removal device snow removal.

In some embodiments, the self-moving device may include a control component and a plurality of crawlers 1000 for improvement of the stability and fluency of the snow sweeping equipment in the moving process. The control component may include components such as a circuit board, and the control component may control the movement of the crawler 1000 to realize the movement of the self-moving device. The plurality of crawlers 1000 may be symmetrically arranged on both sides of the bottom of the self-moving device. For the specific structure of the crawler 1000, please refer to the following embodiments. This application adopts all the technical solutions of all the following embodiments for the snow sweeping equipment, thus it has at least all the beneficial effects brought by the technical solutions of the above embodiments, which will not be repeated here.

In some embodiments, the snow sweeping equipment may also include an ultrasonic range sensor. The snow sweeping equipment has the function of path planning (i.e., obstacle handling ability). For small obstacles, the snow sweeping equipment can automatically cross. For medium and large obstacles, the snow sweeping equipment can avoid them in time and clear up the snow around the obstacles to the maximum extent. The transmitter of the ultrasonic range sensor of the snow sweeping equipment emits ultrasonic waves. The ultrasonic waves meet with obstacles and are reflected. The receiver of the ultrasonic range sensor can measure the distance from obstacles to the snow sweeping equipment based on the time difference between receiving ultrasonic waves. In this way, the snow sweeping equipment can plan ahead to avoid obstacles, avoid collision with obstacles and effectively improve the safety performance of snow sweeping equipment. Apparently, in other embodiments, the snow sweeping equipment may also use infrared ranging sensors or laser distance sensors for obstacle avoidance.

For the description of the present application, it should be noted that unless otherwise specified and defined, the terms “installation” and “connected” should be understood in a broad sense. For example, it may be a fixed connection, a detachable connection, an integral connection or a transmission connection. It can be directly connected or indirectly connected through an intermediate medium. For those of ordinary skill in the art, the specific meanings of the above terms in the present application may be understood in specific situations.

Furthermore, the terms “first” and “second” are merely used to differentiate descriptions and shall not be interpreted as particular or special structures. The phrase “some embodiments” refers to the specific features, structures, materials, or features described by the embodiments or examples, which are included in the embodiments or examples of the application. In this specification, the illustrative expressions of the above terms do not necessarily refer to the same embodiment or example. Furthermore, the specific features, structures, materials, or characteristics described may be combined in any one or more embodiments or examples in an appropriate manner. In addition, without contradicting one another, those skilled in the art may combine various embodiments, examples, and features of various embodiments, examples, and examples described in this specification.

The above embodiments are only used to illustrate the technical solutions of this application, but not to limit it. Although the application has been described in detail with reference to the aforementioned embodiments, those of ordinary skill in the art should understand that the technical solutions described in the aforementioned embodiments may still be modified, or some of the technical features may be equivalently replaced. However, these modifications or substitutions do not make the essence of the technical solutions deviate from the spirit and scope of the technical solutions of each embodiment of this application, and shall be included in the protection scope of this application.

What is claimed is:

1. A crawler, comprising:
a crawler body;
a driving wheel and a driven wheel, wherein the driving wheel and the driven wheel are respectively arranged at two ends of an inner side of the crawler body, so that the driving wheel and the driven wheel are drivingly connected through the crawler body;
a first frame body and a second frame body, wherein the first frame body and the second frame body are respectively arranged at two opposite sides of an axis direction of the driving wheel, so that the driving wheel and the driven wheel are connected;
a first barrier and a second barrier, wherein both the first barrier and the second barrier are arranged between the driving wheel and the driven wheel, a distance between the first barrier and the driving wheel is L1, and 0<L1<5 mm;
a distance between the second barrier and the driven wheel is L2, and 0<L2<5 mm.

2. The crawler of claim 1, wherein 0.5 mm≤L1≤1.5 mm; and/or, 0.5 mm≤L2≤1.5 mm.

3. The crawler of claim 1, wherein the crawler body further comprises a driving mechanism arranged on a side of the first frame body close to the driving wheel; and
an output end of the driving mechanism penetrates through the first frame body to be connected to the driving wheel.

4. The crawler of claim 1, wherein the first barrier is close to the driving wheel; and
the first barrier at least partially covers a rim of the driving wheel along a first direction.

5. The crawler of claim 4, wherein the first direction is a perpendicular direction from an end of the first barrier facing the driving wheel to an axis of the driving wheel.

6. The crawler of claim 1, wherein the second barrier is close to the driven wheel; and
the second barrier at least partially covers a rim of the driven wheel along a second direction.

7. The crawler of claim 6, wherein the second direction is a perpendicular direction from an end of the second barrier facing the driven wheel to an axis of the driven wheel.

8. The crawler of claim 1, wherein the first barrier and the second barrier are both telescopic rods.

9. The crawler of claim 1, wherein the first frame body and the second frame body are connected by a connector, and the connector is positioned between the driving wheel and the driven wheel.

10. The crawler of claim 9, wherein the first barrier is a first bolt, an end of the first bolt is screwed with the connector, and another end of the first bolt faces the driving wheel; and/or
the second barrier is a second bolt, an end of the second bolt is screwed with the connector, and another end of the second bolt faces the driven wheel.

11. The crawler of claim 9, wherein a first gasket is arranged between the first barrier and the connector, and the first barrier penetrates through the first gasket to be connected to the connector; and/or
a second gasket is arranged between the second barrier and the connector, and the second barrier penetrates through the second gasket to be connected to the connector.

12. The crawler of claim 11, wherein when the first gasket is arranged between the first barrier and the connector, a thickness of the first gasket is L3, and 0.1 mm≤L3≤0.5 mm; and
when the second gasket is arranged between the second barrier and the connector, a thickness of the second gasket is L4, and 0.1 mm≤L4≤0.5 mm.

13. A crawler, comprising:
a frame, wherein the frame comprises a first frame body and a second frame body;
a first wheel and a second wheel, wherein the first wheel and the second wheel are rotatably connected to the frame respectively, and the first wheel and the second wheel are opposite to each other and arranged at intervals; one of the first wheel and the second wheel is a driving wheel, and another is a driven wheel; a crawler body is sleeved on a periphery of the first wheel and a periphery of the second wheel, and the crawler body is engaged with the first wheel and the second wheel; and
a snow scraping component, wherein the snow scraping component is at least a part of a first barrier and a second barrier, the snow scraping component is connected to the frame and positioned between the first wheel and the second wheel, and the snow scraping component has a gap “d” with an outer wheel face of the first wheel.

14. The crawler of claim 13, wherein a tangent of the outer wheel face of the first wheel and a plane where the snow scraping component is located form an included angle “a”, and the included angle is obtuse.

15. The crawler of claim 13, wherein a length direction of the snow scraping component is consistent with an axial direction of the first wheel.

16. The crawler of claim 13, wherein the snow scraping component is arranged obliquely downward from the frame.

17. The crawler of claim 13, wherein the snow scraping component comprises a snow scraping part and a snow blocking part connected to each other; one of the snow scraping part and the snow blocking part is connected to the frame, and the snow blocking part extends upward from a side of the snow scraping part away from the first wheel.

18. The crawler of claim 13, wherein the crawler further comprises a snow guiding member connected to the frame, the snow guiding member has a snow guiding face, and the snow guiding face inclines downward from the frame in a direction away from the frame.

19. The crawler of claim 13, wherein the frame has a protrusion structure, the protrusion structure is positioned between the first wheel and the second wheel at intervals, and the snow scraping component is connected to the upper and lower sides of the protrusion structure.

20. A snow sweeping equipment, comprising:
a self-moving device, wherein the self-moving device comprises a plurality of crawlers of any one of claim 1; and
a snow removal device, wherein the snow removal device is installed on the self-moving device.
